(19) United States
(12) Patent Application Publication
(10) Pub. No.: US 2015/0146706 A1
(43) Pub. Date: May 28, 2015

(54) Remotely Provisioning And Operating A Headless WIFI Device

(71) Applicant: Mariano Goluboff, Irvine, CA (US)

(72) Inventor: Mariano Goluboff, Irvine, CA (US)

(73) Assignee: Lantronix, Inc., Irvine, CA (US)

(21) Appl. No.: 14/550,390

(22) Filed: Nov. 21, 2014

Related U.S. Application Data
(60) Provisional application No. 61/907,966, filed on Nov. 22, 2013.
(60) Provisional application No. 61/907,960, filed on Nov. 22, 2013.

(51) Int. Cl. H04W 76/02; H04W 12/06; H04W 84/12

(52) U.S. Cl. CPC H04W 76/02; H04W 84/12; H04W 12/06
USPC 370/338

(57) ABSTRACT

A system and apparatus for remotely provisioning and operating a headless WiFi device is described that provides for provision of the headless WiFi device so as to connect the headless WiFi device to a network, and provides for remote control of the headless WiFi using a mobile device or a monitoring computer. A direct WiFi connection may be established between the mobile device and the headless WiFi device through a software WiFi access point, or, once the headless WiFi device is provisioned onto a network, a network connection may be established. Once established, the connection may switch between the direct connection and the network connection without providing an indication to a user. A mobile device or monitoring computer may be used to control the operation of and receive status information from a legacy device connected to the headless WiFi device. The information received from the legacy device may be transmitted to the mobile device or monitoring computer for display to a user, or the information may be deployed to a web page accessible to the user.

### CROSS-REFERENCES TO RELATED APPLICATIONS

This application claims priority from U.S. Provisional Application Nos. 61/907966 and 61/907960, both of which were filed Nov. 22, 2013, and are incorporated herein in their entireties.

### BACKGROUND

The field of the present invention generally relates to network connections. More particularly, the field of the invention relates to a method and apparatus for remotely provisioning and operating a headless WiFi-enabled device.

In the area of network computing, the term “provisioning” generally refers to the process of configuring a computer, or other network-compatible device, selecting an appropriate network, and establishing a connection to the network. A user interface (UI), or a human machine interface (HMI), stored on a computer, a phone, a laptop, or any other similar computing device, generally shows a user a list of available networks and enables the user to select a desired network to which to connect. The HMI further enables the user to enter a suitable username and password required for connecting the network, and then configure the network connection, if need be.

In this day and age, connecting to networks is far simpler than ever before, and many devices enable users to connect simply by selecting a network and entering a password. Connecting to a network becomes more complicated, however, when the device to be connected lacks any kind of HMI or user interface, frequently referred to as a “headless device.” Those skilled in the art will appreciate that many headless devices may have one or more serial ports, and a common way of configuring the devices is by entering commands via the serial ports. Meanwhile, with Ethernet-enabled devices, connecting to a network may be as simple as plugging in an Ethernet cable. Alternatively, connecting a headless cellular device may often be accomplished with relative ease simply because a Subscriber Identification Module (that is, a SIM card) associated with the cellular device is already provisioned with the connection. In the case of WiFi, however, every device has a different password and settings, which makes provisioning a headless WiFi device very difficult, if not nearly impossible.

A legacy system, or device, is generally defined as any method, technology, computer system, or application program which is outdated by current standards. Although the term “legacy” frequently is used in reference to outdated computer systems, the term often is used to describe any corporate computer system that is not Internet-dependent. There is a wide variety of reasons why organizations might continue using legacy devices. For example, the cost of replacing a particular legacy device with an updated device may be prohibitive. In other instances, the legacy device may be required to be continually available for service, thereby reducing an organization's motivation to take the device offline. Moreover, the cost of designing and installing updated devices which provide a similar degree of availability may be a deterrent. Thus, many organizations have compelling reasons to keep legacy devices in service.

With the advent of the Internet and network computing, there is a growing demand to enable legacy devices to send and receive information by way of computer networks. Although many legacy devices may be equipped with serial ports and Ethernet ports for connecting to the Internet, there is also a wide variety of devices that lack such connectivity. One alternative to physically networking legacy devices is to use wireless network connections.

Another difficulty in networking, or remotely operating, legacy devices is that many legacy devices lack any kind of user interface or human machine interface (HMI). Such devices are frequently referred to as “headless” devices. Those skilled in the art will appreciate that remotely operating a legacy device which lacks a user interface poses a special challenge. Providing a proprietary user interface and coupling a LCD monitor with the legacy device is costly, and may not be practical in many cases.

What has been needed, and heretofore unavailable, is a method and apparatus for provisioning and remotely operating WiFi-enabled devices without any need for a user interface or HMI installed on the devices. The present invention satisfies these, and other needs.

### SUMMARY OF THE INVENTION

In a general aspect, the invention includes a method and an apparatus for provisioning and remotely controlling a headless WiFi device by way of a mobile WiFi device. The mobile WiFi device may be any device capable of participating in wireless connections with various network access points within a multiplicity of infrastructure networks.

In one aspect, the headless WiFi device may be any WiFi-enabled device which lacks a user interface or a Human Machine Interface (HMI), and which typically is connected to a device incapable of otherwise establishing an Internet connection. For example, a headless WiFi device may be connected to a legacy device via, for example, a serial or “com” port to provide an Internet connection to the legacy device.

In another aspect, a wireless network interface controller of the headless WiFi device may support both a client WiFi interface and a software WiFi access point. The client WiFi interface is configured to establish wireless connections with network access points, as well as the Internet. The software access point is configured to publish itself as an available access point whereby a mobile WiFi device may discover and connect to the headless WiFi device using typical WiFi communication protocols. The access point provided by the software access point appears and functions as though it is an ordinary network access point, but in actuality the software access point provides no network or Internet connectivity, it merely provides a portal that can be connected to using a specialized software application that has been downloaded and installed onto the mobile WiFi device.

In yet another aspect, the specialized software application stored on the mobile WiFi device is configured to automatically detect and scan the characteristics of all available access points, including the pseudo access point provided by the software access point, and to distinguish between network access points and those that are “headless,” such as the software access point. A user of the mobile WiFi device may select the software access point on a list of available access points that is presented on the mobile WiFi device. The user will typically be asked to provide an appropriate password to access the software access point to ensure that the user is authorized to access the software access point.

In still another aspect, once the password is authenticated by the specialized software application, the specialized software application automatically establishes a wireless connection with the headless WiFi device by way of the software access point, at which point the mobile WiFi device functions as a user interface for the headless WiFi device. In other words, once the wireless connection between the headless WiFi device and the mobile device is established, the mobile device may be used, via a typical request/response protocol, such as, for example, an HTTP protocol, to control the operation of the headless WiFi device, and to configure, or provision, the headless WiFi device appropriately to allow the headless WiFi device to connect to an access point that provides the headless WiFi device with a connection to another network, or the Internet.

In yet another aspect, security settings stored in the headless WiFi device are configured by the specialized software application, based on the detected security settings of the discovered network access points. The user need only select a desired network access point and then enter an appropriate password. The software application authenticates the headless WiFi device by way of the client WiFi interface, such that a wireless connection is established between the headless WiFi device and the selected network access point. The specialized software application stored on the mobile WiFi device coupled with the software access point enables the user to deploy the headless WiFi device on the selected network without requiring specialized technical training on the part of the user.

In another general aspect, the present invention includes a method and apparatus for remotely operating a headless WiFi device coupled to a legacy device. The headless WiFi device is a WiFi-enabled device that lacks a user interface or a Human Machine Interface (HMI). The legacy device is incapable of establishing an Internet connection in the absence of the headless WiFi device. A wireless network interface controller (WiFi) within the headless WiFi device comprising a client WiFi interface and a software WiFi access point. The client WiFi interface is configured to establish wireless connections with network access points, and the software access point is configured to publish itself as an available access point whereby a mobile WiFi device may connect to the headless WiFi device. The software access point appears and functions as though it is one of the network access points, but provides no connectivity to the network, or to the Internet. The mobile WiFi device preferably is a mobile phone or a tablet computer, or other portable computing device capable of participating in a wireless connection. A software application stored on a non-transitory machine-readable medium of the mobile WiFi device is configured to automatically establish a WiFi connection between the mobile WiFi device and the headless WiFi device by way of the software access point. Once the mobile WiFi device and the headless WiFi device are connected, the software application effectively operates as a user interface for the headless WiFi device, thereby enabling a user to remotely operate and monitor the legacy device.

In one aspect, the mobile WiFi device may be used to remotely operate the headless WiFi device, and thus the legacy device, by way of a network connection. In one alternative aspect, the connection between the headless WiFi device and the mobile WiFi device may switch between the software access point and the network connection, as needed, without any knowledge on the part of the user of the mobile WiFi device.

In yet another aspect, a monitoring computer may be used instead of the mobile WiFi device. In another embodiment, the monitoring computer may be a non-portable computing equipment with wireless connectivity. In another aspect, the headless WiFi device may periodically send information about the status of the legacy device to the monitoring computer.

In still another aspect, the monitoring computer includes a software application which receives the information sent by the headless WiFi device and then displays the information to the user. In yet another aspect, the information sent by the headless WiFi device may be deployed as a Webpage on the network, which periodically updates and displays new information received from the headless WiFi device. In still another alternative aspect, the monitoring computer may be configured to receive machine-to-machine communications from the headless WiFi device.

In another aspect, the invention includes a system for provisioning a headless WiFi device, comprising: a headless WiFi device having a wireless network interface controller and a memory, the wireless network interface controller configured to be controlled by software programming commands to provide a client WiFi interface and a software WiFi access point, the client WiFi interface configured to establish wireless connections with network access points and the software WiFi access point is configured to publish itself as an available access point; a mobile WiFi device having a processor, the processor being in operable communication with a memory and a mobile wireless network interface controller configured to be controlled by software programming commands to provide a mobile client WiFi interface configured to establish wireless connections with network access points and the software WiFi access point of the headless WiFi device; and a software application stored on the memory of the mobile WiFi device, the software application consisting of programming commands for controlling the processor of the mobile WiFi device to establish a wireless connection through with the headless WiFi device through the mobile wireless network interface controller by way of the software WiFi access point, and to provide values of configuration parameters associated with the network access points to authenticate the headless WiFi device on a user selected network through the client WiFi interface of the headless WiFi device, such that a wireless connection is established between the headless WiFi device and the user selected network.

In one alternative aspect, the software application is configured to use the mobile client WiFi interface to automatically detect and scan characteristics of all available access points. In another aspect, the headless WiFi device is a WiFi-enabled device that lacks a user interface or a Human Machine Interface (HMI). In still another aspect, the mobile WiFi device functions as a user interface for the headless WiFi device. In another aspect, the mobile WiFi device is a mobile phone or a tablet computer.

In yet another aspect, the headless WiFi device is connected to a device which is otherwise incapable of establishing an Internet connection. In another aspect, the software WiFi access point appears and functions as a network access point, but provides no connectivity to the network access points. In still another aspect, the software application is configured to distinguish between network access points suitable for network access and network access points that are headless. In another aspect, the software application enables a user of the mobile WiFi device to select a network access point from a list of available access points and then enter an appropriate password for the selected network access point.

In still another aspect, the values of the configuration parameters are security settings stored in the memory of the headless WiFi device, the security settings being selected by the processor of the mobile WiFi device based on security settings of the selected network access point detected by the mobile WiFi client interface.

In yet another aspect, the invention includes an apparatus for remotely operating a headless WiFi device coupled to a legacy device, comprising: a headless WiFi device having a wireless network interface controller and a memory, the wireless network interface controller configured to be controlled by software programming commands to provide a client WiFi interface and a software WiFi access point, the client WiFi interface configured to establish wireless connections with network access points and the software WiFi access point is configured to publish itself as an available access point, the headless WiFi device also having a first wired communication port; a mobile WiFi device having a processor, the processor being in operable communication with a memory and a mobile wireless network interface controller configured to be controlled by software programming commands to provide a mobile client WiFi interface configured to establish wireless connections with network access points and the software WiFi access point of the headless WiFi device; a legacy device having a second wired communication port configured for communicating with the headless WiFi device through the first communication port; and, a software application stored on the memory of the mobile WiFi device, the software application consisting of programming commands for controlling the processor of the mobile WiFi device to establish a wireless connection through with the headless WiFi device through the mobile wireless network interface controller to remotely control the legacy device through the headless WiFi device.

In one aspect, the software WiFi access point appears and functions as though it is one of the network access points, but provides no connectivity to the network.

In another aspect, the mobile WiFi device is a mobile phone or a tablet computer. In an alternative aspect, the mobile WiFi device is a portable computing device capable of participating in a wireless connection. In one alternative aspect, the mobile WiFi device is a monitoring computer. In another alternative aspect, the monitoring computer is non-portable computing equipment with wireless connectivity.

In yet another aspect, the headless WiFi device is a WiFi-enabled device that lacks a user interface or a Human Machine Interface (HMI).

In still another aspect, the wireless connection between the mobile WiFi device and the headless WiFi device is a wireless network connection through the mobile wireless network interface through the network and through the wireless client interface of the headless WiFi device or a direct connection between the mobile WiFi device and the headless WiFi device by way of the mobile client network interface and the software WiFi access point, such that the legacy device is remotely controlled by the mobile WiFi device.

In yet another aspect, the connection between the headless WiFi device and the mobile WiFi device may switch between the direct connection and the network connection. In one alternative aspect, the connection may switch between the direct connection and the network connection without providing an indication to a user of the apparatus that the connection has switched.

In still another aspect, the headless WiFi device periodically sends information related to a status of the legacy device from the legacy device to the monitoring computer through the headless WiFi device.

In yet another aspect, the monitoring computer includes a processor configured by software programming commands to receive the information sent by the headless WiFi device and to display the information to a user. In another aspect, the information is accessible by the monitoring computer from a Webpage on the network, the Webpage being periodically updated as more recent information is received from the headless WiFi device.

In still another aspect, the monitoring computer is configured to receive machine-to-machine communications from the headless WiFi device.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1 is a block diagram illustrating an embodiment of an exemplary use environment wherein a headless WiFi device is provisioned by way of a mobile WiFi device in accordance with the present invention.

FIG. 2 is a block diagram illustrating an embodiment of an exemplary use environment wherein a headless WiFi device is remotely operated by way of a mobile WiFi device in accordance with the present invention.

FIG. 3 is a block diagram illustrating an embodiment of an exemplary use environment wherein a headless WiFi device is remotely operated by way of a mobile WiFi device in accordance with the present invention.

FIG. 4 is a block diagram illustrating an embodiment of an exemplary use environment wherein a headless WiFi device is remotely monitored by way of a monitoring computer in accordance with the present invention.

FIG. 5 is a block diagram illustrating an embodiment of an exemplary use environment wherein a headless WiFi device is configured to communicate information from a legacy device to a server that is configured to display the information from the legacy device as a web page.

FIG. 6 is a block diagram illustrating an embodiment of an exemplary headless WiFi device.

### DETAILED DESCRIPTION OF THE PREFERRED EMBODIMENTS

As will be described hereinafter in greater detail, the various embodiments of the present invention relate to an apparatus and method for provisioning and remotely operating a headless WiFi device, including where the headless WiFi device is connected to and in communication with a legacy device that has no UI or HMI for controlling the legacy device. For purposes of explanation, specific nomenclature is set forth to provide a thorough understanding of the present invention. Description of specific applications and methods are provided only as examples. Various modifications to the embodiments will be readily apparent to those skilled in the art and the general principles defined herein may be applied to other embodiments and applications without departing from the spirit and scope of the invention. Thus the present invention is not intended to be limited to the embodiments shown, but is to be accorded the widest scope consistent with the principles and steps disclosed herein.

In the following description, numerous specific details are set forth in order to provide a thorough understanding of the present invention. It will be apparent, however, to one of ordinary skill in the art, that the present invention may be practiced without these specific details. In other instances, well known components or methods have not been described in detail but rather in a block diagram, or a schematic, in order to avoid unnecessarily obscuring the present invention. Further specific numeric references such as “first driver,” may be made. However, the specific numeric reference should not be interpreted as a literal sequential order but rather interpreted that the “first driver” is different than a “second driver.” Thus, the specific details set forth are merely exemplary. The specific details may be varied from and still be contemplated to be within the spirit and scope of the present invention. The term “coupled” is defined as meaning connected either directly to the component or indirectly to the component through another component.

Throughout the description reference will be made to various software programs and hardware components that provide and carryout the features and functions of the various embodiments of the present invention. Software programs may be embedded onto a machine-readable medium. A machine-readable medium includes any mechanism that provides, stores or transmits information in a form readable by a machine, such as, for example, a computer, server or other such device. For example, a machine-readable medium includes read only memory (ROM); random access memory (RAM); magnetic disk storage media; optical storage media; flash memory devices; digital video disc (DVD); EPROMs; EEPROMs; flash memory; magnetic or optical cards; or any type of media suitable for storing electronic instructions.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms may be written in a number of different software programming languages. Also, an algorithm may be implemented with lines of code in software, configured logic gates in software, or a combination of both.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

In an embodiment, the logic consists of electronic circuits that follow the rules of Boolean Logic, software that contain patterns of instructions, or any combination of both.

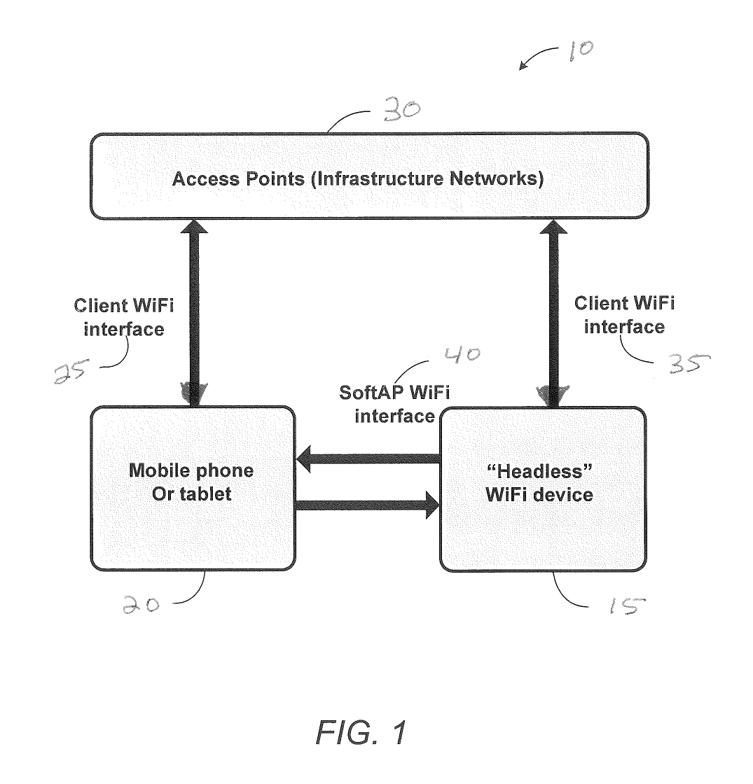

FIG. 1 is a block diagram illustrating an embodiment of an exemplary use environment 10 wherein a headless WiFi device 15 is provisioned by way of a mobile WiFi device 20 in accordance with the present invention. The mobile WiFi device 20 may be, for example, a mobile phone or a tablet computer. In other embodiments, however, the mobile WiFi device may be any computing device capable of participating in a wireless connection.

The mobile WiFi device 20 comprises a client WiFi interface 25 which is suitably configured to establish wireless connections with various access points 30 within a multiplicity of infrastructure networks. The mobile WiFi device will include at least one processor and at least one memory for storing operating system software that controls the operation of the processor. As described above, the mobile WiFi device also includes a communication bus and associated circuitry providing connectivity to access points 30, or to other communication systems, such as, for example, a cellular network or the like.

The operating software is configured to cooperate and interface with various software applications that may be installed into the memory of the mobile WiFi device. Typically, the mobile WiFi device also includes a display, which may be a touch screen, which is used not only to display information to a user of the mobile WiFi device, but is also used to input information, and to select applications to run on the mobile WiFi device, or to select and call various functions of the operating software to control the processor to carry out selected functions of the mobile WiFi device.

As described above, a specialized software application (not shown) may be stored in the memory of the mobile WiFi device. The specialized software application includes commands and data required to program or configure the processor of the mobile WiFi device to carry out the various functions and processes of the specialized software application. It will be understood that, when reference is made to connecting to the headless WiFi device, provisioning the headless WiFi device, and remotely controlling the headless WiFi device, those functions are being carried out under the control of the specialized software application stored in the memory of the mobile WiFi device.

The headless WiFi device 15 may be any WiFi-enabled device that lacks a user interface or a Human Machine Interface (HMI). It is envisioned that the headless WiFi device 15 typically is connected to a legacy device, or any device which is otherwise incapable of establishing an Internet connection. The headless WiFi device 15 comprises a wireless network interface controller (WiFi) which supports both a client WiFi interface 35 and a software WiFi access point (“SoftAP”) 40. The client WiFi interface 35 is configured to establish wireless connections with the access points 30. The SoftAP 40 is configured to publish itself as an available access point whereby the mobile WiFi device 20 may connect to the headless WiFi device 15. It will be appreciated by those skilled in the art that the SoftAP 40 appears and functions as though it was one of the access points 30, but in actuality the SoftAP 40 provides no network connectivity to the access points 30, or to the Internet.

During initialization of the headless WiFi device 15, the client WiFi interface 35 must be provisioned before the headless WiFi device 15 can successfully connect to the access points 30. As described above, the mobile WiFi device 20 includes a specialized software application, stored on the memory of the mobile WiFi device, which may be on a non-transitory machine-readable medium of the mobile WiFi device 20.

The specialized software application, when activated by a user of the mobile WiFi device 20, is configured to automatically detect and scan the characteristics of all available access points 30, including the SoftAP 40, by way of the client WiFi interface 25. The specialized software application is configured to distinguish between access points 30, which are suitable for Internet access, and those that are “headless,” such as the pseudo access point of the SoftAP 40.

In an alternative embodiment, the specialized software application of mobile WiFi device 20 may also be configured to continuously listen and discover pseudo access points, such as that of SoftAP 40. In this manner, the specialized software application may notify a user of mobile WiFi device 20 of the existence of the SoftAP 40 access point.

A user of the mobile WiFi device 20 may select various access points from a list and then provide an appropriate password for the selected network. Once the user selects the SoftAP 40 and enters a password, after authenticating the password, the software application automatically establishes a WiFi connection with the headless WiFi device 15 by way of the SoftAP 40.

The specialized software application of mobile WiFi device 20 uses the client WiFi interface 25 to detect various security settings associated with access points 30. The specialized software application configures the security settings that are stored in the headless WiFi device 15 based on the detected security settings of the access points 30. The user need only select a desired access point 30 and then enter an appropriate password. The software application automatically authenticates the headless WiFi device 15 by way of the client WiFi interface 25 and the client WiFi interface 35, such that a wireless connection is established between the headless WiFi device 15 and the selected access point 30. It will be appreciated that in the present invention, the mobile WiFi device 20 effectively operates as the HMI for the headless WiFi device 15. It will be further appreciated that the specialized software application stored on the mobile WiFi device 20 coupled with the SoftAP 40 enables the user to authenticate and deploy the headless WiFi device 15 on the network without requiring specialized technical training on the part of the user.

When the mobile WiFi device 20 has detected the security and other configuration settings necessary to establish a connection with access points 30, the specialized software running on the mobile WiFi device 20 opens a communication system with a web manager operating on the headless WiFi device 15 using an appropriate communication protocol, such as, for example, an HTTP protocol. In this manner, the specialized software communicates with the web manager of the headless WiFi device 15 to retrieve the status of the headless device, and to export configuration parameters associated with the access points 30 to the web manager of the headless WiFi device 15.

It will be appreciated that the headless WiFi device includes at least one processor and at least one memory or storage device in communication with the processor, the processor being programmed by software commands to carry out various functions, including the functions of the various embodiments of the present invention. These software commands may be stored in the memory or storage device and are accessible by the processor, or they may be embedded in the circuitry of the processor. In one embodiment, the headless WiFi device also includes a communication bus and various communication ports to allow for connection of the headless WiFi device to a network or the Internet, as well as for providing connection to other devices, such as legacy devices, that utilize the headless WiFi device to connect to a network or the Internet.

In one embodiment, one of the software programs stored on the memory of the headless WiFi device may be a web manager. The web manager is a software program that includes software commands for managing communications between the processor and configuration files stored in the memory of the headless WiFi device and networks connected to the headless WiFi device. One such web manager may be WebAPI manufactured and distributed by Lantronix, Inc. In some embodiments, the SoftAP WiFi interface 40 is incorporated into the web manager.

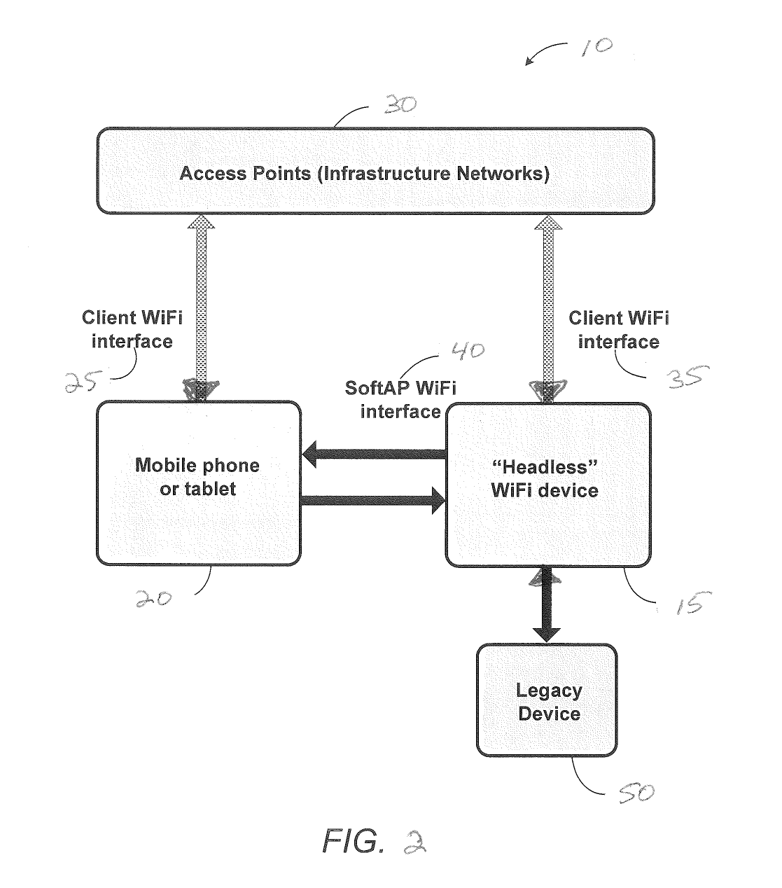

Referring now to FIG. 2, which illustrates a legacy device 50 connected to headless WiFi device 15. The specialized software application of the mobile WiFi device 20 may also include programming commands that enable a user of the mobile WiFi device to remotely control the legacy device 50 connected to the headless WiFi device 15 once the headless WiFi device has been provisioned onto a network through access points 30.

In an exemplary embodiment, the connection between the headless WiFi device 15 and the mobile WiFi device 20 may switch between the SoftAP 40 and the network connection via access points 30, as needed, without any knowledge on the part of the user of the mobile WiFi device. In another exemplary embodiment, a monitoring computer (not shown) may be used instead of the mobile WiFi device 20. In another embodiment, the monitoring computer may be a non-portable computing equipment with wireless connectivity.

In other embodiments, the headless WiFi device may periodically send information about the status of the legacy device to the monitoring computer. It is envisioned that the monitoring computer includes a specialized software application that is run by a processor of the monitoring computer to configure the processor to receive the information sent by the headless WiFi device through the network connection between the monitoring computer and headless WiFi device and to display the information to the user on a display in operable communication with the processor of the monitoring computer.

In still another embodiment, the information transmitted by the headless WiFi device from the legacy device may be deployed as a Webpage on the network, which periodically updates and displays new information received from the headless WiFi device. In another embodiment, the monitoring computer may be configured to receive machine-to-machine communications from the headless WiFi device.

It will be appreciated by those skilled in the art that although the client WiFi interfaces 25, 35 are configured to connect to the network access points 30, the SoftAP 40 enables the mobile WiFi device 20 to connect directly to the headless WiFi device 15 without first establishing a network connection by way of the network access points 30. Thus, the legacy device 50 may be operated by way of the mobile WiFi device 20 over a direct WiFi connection.

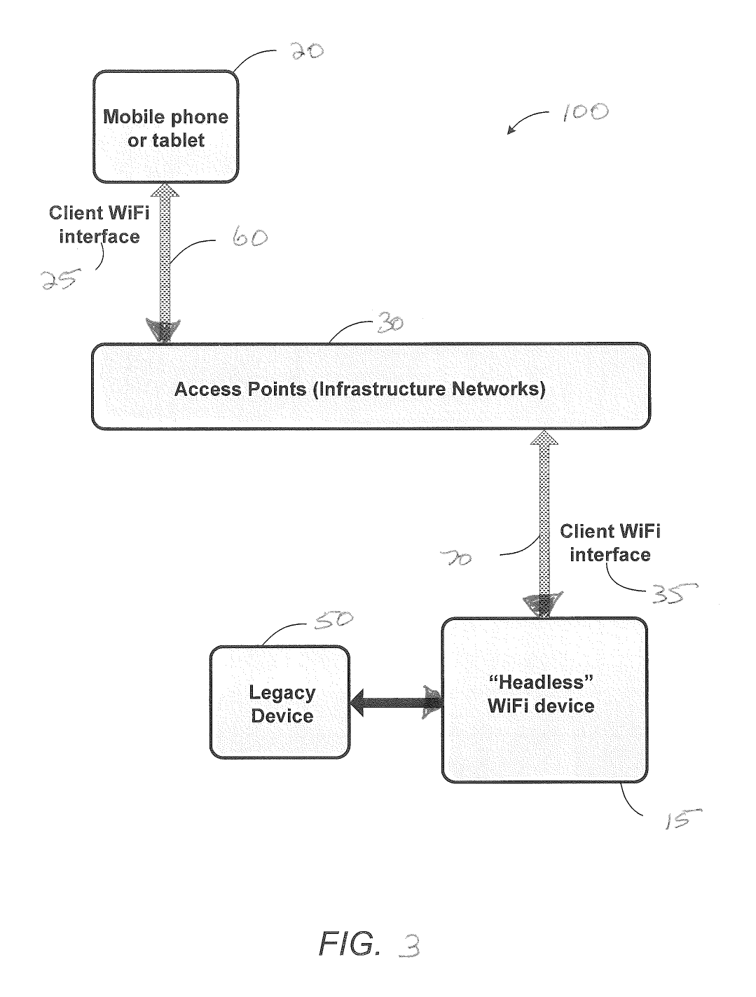

However, there may be instances wherein network connectivity may be advantageous, such as when the mobile WiFi device 20 is too far away from the headless WiFi device 15 for a direct WiFi connection to be established between mobile WiFi device 20 and headless WiFi device 15. FIG. 3 illustrates an embodiment of an exemplary use environment 100 wherein the headless WiFi device 15, and thus the legacy device 50, is remotely operated by the mobile WiFi device 20 by way of network connections 60, 70. Remotely operating the legacy device 50 by way of the network connections 60, 70 is substantially similar to operating the legacy device 50 by way of the SoftAP 40, with the exception that the mobile WiFi device 20 and the headless WiFi device 35 must be first authenticated and deployed on the network.

Once the network connections 60, 70 are established and the mobile WiFi device 20 and the headless WiFi device 15 are communicating over the network, the specialized software application on the mobile WiFi device 20 enables the user to remotely operate and monitor the legacy device 50 by entering commands on the mobile WiFi device 20. Thus, the specialized software application on the mobile WiFi device 20 operates as the HMI for the headless WiFi device 15, just as described above in connection with FIG. 1.

It is envisioned that in some embodiments, the connection between the headless WiFi device 20 and the mobile WiFi device 15 may switch between the SoftAP 40 and the network access points 30, as needed, without any knowledge on the part of the user of the mobile WiFi device 20. It will be appreciated that the software application stored on the mobile WiFi device 20 coupled with the SoftAP 40 enables the user to connect with the headless WiFi device 15, and thereby remotely operate the legacy device 50 without any prior specialized technical training being required on the part of the user.

It will be appreciated by those skilled in the art that the various embodiments of the invention are not limited to using the mobile WiFi device 20 to remotely monitoring and operating the legacy device 50, but rather other types of machines may be used to remotely operate the legacy device 50 in accordance with the present invention.

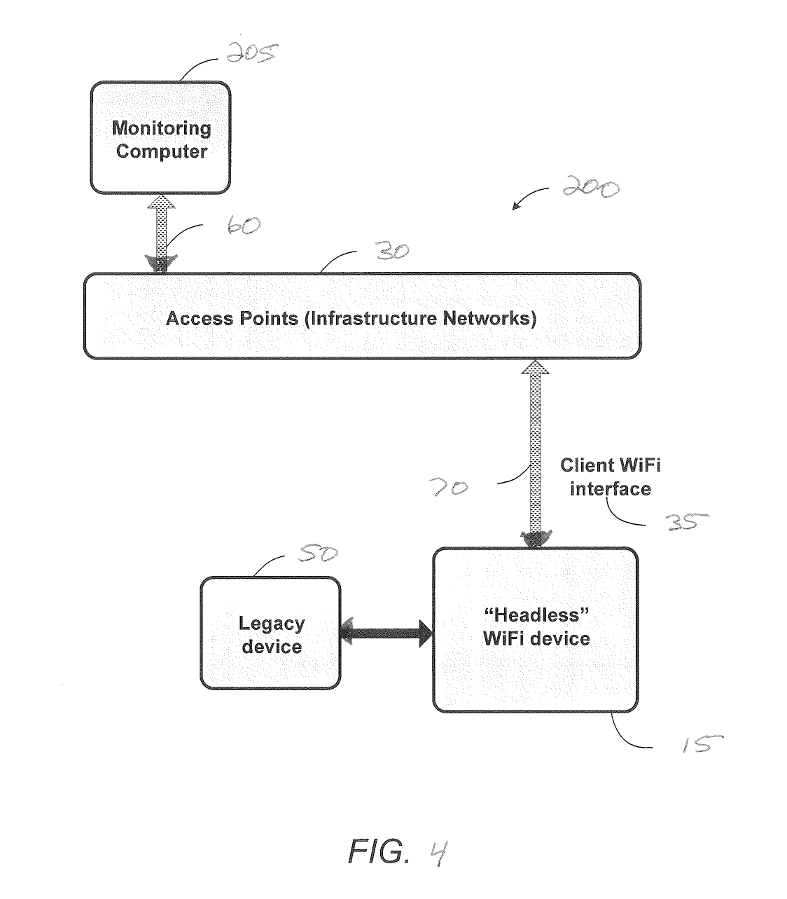

FIG. 4 illustrates an embodiment of an exemplary use environment 200 wherein the headless WiFi device 15 and the legacy device 50 are remotely monitored by way of a monitoring computer 205 by way of the network connections 60, 70. In an embodiment, the monitoring computer 205 may be a mobile phone or a tablet computer, as described above with reference to FIG. 1. In other embodiments, monitoring computer 205 may be any portable computing device capable of participating in a wireless connection. In still other embodiments, monitoring computer 205 may be a non-portable computing equipment with wireless connectivity, such as, by way of example, computers used in factories, manufacturing, automated assembly lines, and the like. Similarly, it is envisioned that the legacy device 50 may be comprised of equipment used in manufacturing and assembly environments, or any other similar environment wherein legacy devices are used.

In an exemplary embodiment, headless WiFi device 15 may periodically send information about the status of the legacy device 50, or other useful information, to the monitoring computer 205. In an exemplary embodiment, monitoring computer 205 comprises a specialized software application, substantially similar to the software application described in connection with FIGS. 1-3, wherein the specialized software application receives the information sent by the headless WiFi device 15 and then displays the information to the user.

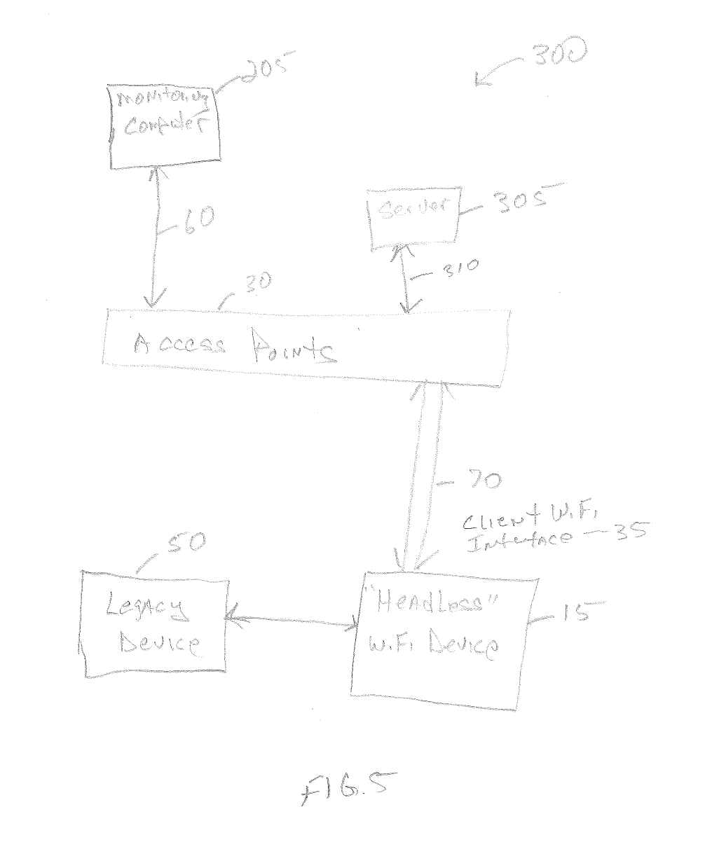

FIG. 5 illustrates another embodiment wherein information from the headless WiFi 15 may be deployed as a Webpage on the network, which periodically updates and displays new information received from the headless WiFi device 15. In this embodiment, information retrieved from legacy device 50 is transmitted by the headless WiFi device 15 through network connection 70 and access points 30 to a server 305 connected to the network via network connection 305. Server 305 is configured using programming commands to host a web page (not shown) on which server 305 displays the information received by server 305 from headless WiFi device 15. Monitoring computer 205 may be configured to access server 305 through network connection 60, 310 and, using HTTP commands, retrieve the information from server 305 and display the information in the form of a web page on a display associated with the monitoring computer 205. In one embodiment, server 305 may reside on monitoring computer 205, or, as shown in FIG. 5, server 305 may be running on a processor remote from monitoring computer 205. In still another embodiment, a web server may be incorporated into the software commands that operated the processor of the headless WiFi device 15.

In still another embodiment, the monitoring computer 205 may be configured to receive machine-to-machine communications from the headless WiFi device 15 and then respond accordingly in absence of a human user. It will be appreciated by those skilled in the art that the client WiFi interface 35 and the SoftAP 40 of the headless WiFi device 15 may be coupled with a wide variety of different monitoring computers 205 and mobile WiFi devices 20 without deviating from the spirit and scope of the present invention.

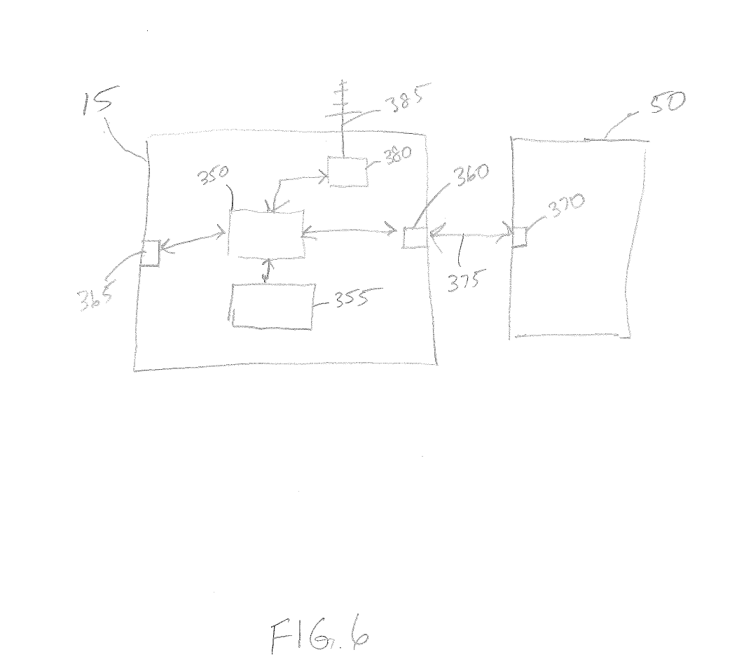

FIG. 6 illustrates additional details of an exemplary embodiment depicting the headless WiFi device 15. In this embodiment, headless WiFi device 15 includes, but is not limited to, a processor 350 and a memory 355 which is in operable communication with the processor 350. The headless WiFi device 15 may also include a serial port 360 and an Ethernet port 365. The headless WiFi device 15 also includes a communication bus and interface (not shown), which couples the processor to the serial port 360 and Ethernet port 365.

The processor 350 is configured and controlled using programming consisting of various software commands which may be stored in memory 355. The processor operates in accordance with software commands to facilitate communications between the headless WiFi device 15 and other devices, such as, for example, legacy device 50 having serial port 370. The programming may be written in any suitable programming language that is capable of being run by the processor, in compiled form in some instances, and in as written form in other instances, such as when providing network services based on hypertext markup language.

Headless WiFi device 15 communicates with legacy device 50 through serial communication port 360 over serial connection 375, which may be a serial cable capable of carrying signals conforming to the RS232 standard between the device server and the serial device. Serial connection 375 connects serial port 360 of the headless WiFi device 15 to serial port 370 of the legacy device 50.

Headless WiFi device 15 may also includes an Ethernet port 365, which facilitates connection to a wired Ethernet based network. Alternatively, device server may also include a wireless transmitter/receiver 380 which is configured to be controlled by the processor 350 to send and receive information through antenna 385 through a wireless network.

It will be understood by those skilled in the art that the network or Internet may comprise one or more servers, databases, and associated memory or other storage facilities, as well as appropriate communication circuitry and interfaces to facilitate information flow between the user and device server. Various software programs may also be run on the mobile WiFi device, the headless WiFi device 15, and any or all of the servers comprising the network to allow for bidirectional communication of information through the network.

While particular embodiments of the present invention have been described, it is understood that various different modifications within the scope and spirit of the invention are possible. The invention is limited only by the scope of the appended claims.

I claim:

1. A system for provisioning a headless WiFi device, comprising:
a headless WiFi device having a wireless network interface controller and a memory, the wireless network interface controller configured to be controlled by software programming commands to provide a client WiFi interface and a software WiFi access point, the client WiFi interface configured to establish wireless connections with network access points and the software WiFi access point is configured to publish itself as an available access point;
a mobile WiFi device having a processor, the processor being in operable communication with a memory and a mobile wireless network interface controller configured to be controlled by software programming commands to provide a mobile client WiFi interface configured to establish wireless connections with network access points and the software WiFi access point of the headless WiFi device; and
a software application stored on the memory of the mobile WiFi device, the software application consisting of programming commands for controlling the processor of the mobile WiFi device to establish a wireless connection through with the headless WiFi device through the mobile wireless network interface controller by way of the software WiFi access point, and to provide values of configuration parameters associated with the network access points to authenticate the headless WiFi device on a user selected network through the client WiFi interface of the headless WiFi device, such that a wireless connection is established between the headless WiFi device and the user selected network.

2. The system of claim 1, wherein the software application is configured to use the mobile client WiFi interface to automatically detect and scan characteristics of all available access points.

3. The apparatus of claim 1, wherein the headless WiFi device is a WiFi-enabled device that lacks a user interface or a Human Machine Interface (HMI).

4. The apparatus of claim 1, wherein the mobile WiFi device functions as a user interface for the headless WiFi device.

5. The apparatus of claim 1, wherein the mobile WiFi device is a mobile phone or a tablet computer.

6. The apparatus of claim 1, wherein the headless WiFi device is connected to a device which is otherwise incapable of establishing an Internet connection.

7. The apparatus of claim 1, wherein the software WiFi access point appears and functions as a network access point, but provides no connectivity to the network access points.

8. The apparatus of claim 1, wherein the software application is configured to distinguish between network access points suitable for network access and network access points that are headless.

9. The apparatus of claim 1, wherein the software application enables a user of the mobile WiFi device to select a network access point from a list of available access points and then enter an appropriate password for the selected network access point.

10. The apparatus of claim 9, wherein the values of the configuration parameters are security settings stored in the memory of the headless WiFi device, the security settings being selected by the processor of the mobile WiFi device based on security settings of the selected network access point detected by the mobile WiFi client interface.

11. An apparatus for remotely operating a headless WiFi device coupled to a legacy device, comprising:
a headless WiFi device having a wireless network interface controller and a memory, the wireless network interface controller configured to be controlled by software programming commands to provide a client WiFi interface and a software WiFi access point, the client WiFi interface configured to establish wireless connections with network access points and the software WiFi access point is configured to publish itself as an available access point, the headless WiFi device also having a first wired communication port;
a mobile WiFi device having a processor, the processor being in operable communication with a memory and a mobile wireless network interface controller configured to be controlled by software programming commands to provide a mobile client WiFi interface configured to establish wireless connections with network access points and the software WiFi access point of the headless WiFi device;
a legacy device having a second wired communication port configured for communicating with the headless WiFi device through the first communication port; and,
a software application stored on the memory of the mobile WiFi device, the software application consisting of programming commands for controlling the processor of the mobile WiFi device to establish a wireless connection through with the headless WiFi device through the mobile wireless network interface controller to remotely control the legacy device through the headless WiFi device.

12. The apparatus of claim 11, wherein the software WiFi access point appears and functions as though it is one of the network access points, but provides no connectivity to the network.

13. The apparatus of claim 11, wherein the mobile WiFi device is a mobile phone or a tablet computer.

14. The apparatus of claim 11, wherein the mobile WiFi device is a portable computing device capable of participating in a wireless connection.

15. The apparatus of claim 11, wherein the headless WiFi device is a WiFi-enabled device that lacks a user interface or a Human Machine Interface (HMI).

16. The apparatus of claim 11, wherein the wireless connection between the mobile WiFi device and the headless WiFi device is a wireless network connection through the mobile wireless network interface through the network and through the wireless client interface of the headless WiFi device or a direct connection between the mobile WiFi device and the headless WiFi device by way of the mobile client network interface and the software WiFi access point, such that the legacy device is remotely controlled by the mobile WiFi device.

17. The apparatus of claim 16, wherein the connection between the headless WiFi device and the mobile WiFi device may switch between the direct connection and the network connection.

18. The apparatus of claim 17, wherein the connection may switch between the direct connection and the network connection without providing an indication to a user of the apparatus that the connection has switched.

19. The apparatus of claim 1, wherein the mobile WiFi device is a monitoring computer.

20. The apparatus of claim 19, wherein the monitoring computer is non-portable computing equipment with wireless connectivity.

21. The apparatus of claim 19, wherein the headless WiFi device periodically sends information related to a status of the legacy device from the legacy device to the monitoring computer through the headless WiFi device.

22. The apparatus of claim 21, wherein the monitoring computer includes a processor configured by software programming commands to receive the information sent by the headless WiFi device and to display the information to a user.

23. The apparatus of claim 21, wherein the information is accessible by the monitoring computer from a Webpage on the network, the Webpage being periodically updated as more recent information is received from the headless WiFi device.

24. The apparatus of claim 19, wherein the monitoring computer is configured to receive machine-to-machine communications from the headless WiFi device.
